(19) United States
(12) Patent Application Publication
(10) Pub. No.: US 2017/0005939 A1
(43) Pub. Date: Jan. 5, 2017

(54) CONTROL METHOD AND NETWORK DEVICE

(71) Applicant: FUJITSU LIMITED, Kawasaki-shi (JP)

(72) Inventors: Motoyuki Tanisho, Yokohama (JP); Tetsuo Ehara, Yokohama (JP); Norihide Kubota, Kawasaki (JP); Shigeru Tsukada, Inagi (JP); Yuji Tanaka, Inagi (JP)

(73) Assignee: FUJITSU LIMITED, Kawasaki-shi (JP)

(21) Appl. No.: 15/187,969

(22) Filed: Jun. 21, 2016

(30) Foreign Application Priority Data
Jul. 1, 2015 (JP) 2015-132606

(51) Int. Cl. H04L 12/819; H04L 12/841; H04L 12/813

(52) U.S. Cl. CPC H04L 47/215; H04L 47/20; H04L 47/28; H04L 47/22

(57) ABSTRACT

A control method performed by a network device includes replenishing a token to a token bucket and updating a timestamp indicating an execution time point of a meter operation when a user packet is received from another device, generating a dummy packet different from the user packet for every certain time period, in response to the dummy packet, replenishing the token to the token bucket, updating the timestamp, and discarding the dummy packet, controlling traffic in accordance with the token within the token bucket.

### CROSS-REFERENCE TO RELATED APPLICATION

This application is based upon and claims the benefit of priority of the prior Japanese Patent Application No. 2015-132606, filed on Jul. 1, 2015, the entire contents of which are incorporated herein by reference.

### FIELD

The embodiments discussed herein are related to a control technique of output rate of packets.

### BACKGROUND

A policing function, which is one of the quality of service (QoS) functions of a network device, is a function of monitoring an output rate of user packets and imposes a penalty on a user packet having an output rate that exceeds a reference value. In a network processing unit (NPU) of a network device, meter operation is performed for implementing a policing function. Meter operation is realized by using a token bucket scheme, and the algorithm employed is Metro Ethernet Forum (MEF) 10 or Request for Comments (RFC) 2698, for example. The meter operation is an operation for metering an amount of tokens in the packet.

FIG. 1 illustrates an outline of MEF 10. In the MEF 10, a Committed Bucket (hereafter, referred to as CB) and an Excess Bucket (hereafter, referred to as EB) are used. Committed information rate (CIR) is an amount of tokens per unit time that are replenished to a CB and represents the minimum guaranteed bandwidth in traffic. Committed burst size (CBS) is the maximum amount of tokens that can be stored in a CB. Committed bucket level at a given time t (CBL(t)) is an amount of tokens at time (t) when a meter operation is performed. When the packet length P is less than or equal to the CBL(t), a frame is determined as “Green” and, when P is greater than the CBL(t), a frame is determined as “Yellow”. Tokens exceeding CBS are stored in an EB if a coupling flag is 1 and discarded if the coupling flag is 0. When “Green” or “Yellow” is determined, tokens corresponding to P bytes are removed from the CB.

Excess information rate (EIR) is an amount of tokens per unit time that are replenished to an EB and represents a bandwidth that can be temporarily used when an output rate exceeds CIR. Excess burst size (EBS) is the maximum amount of tokens that can be stored in an EB, and tokens corresponding to the portion that exceeds an EB are discarded. Excess bucket level at a given time t (EBL(t)) is an amount of tokens at time (t) when a meter operation is performed. When the packet length P is less than or equal to the EBL(t), a frame is determined as “Yellow,” and when P is greater than the EBL(t), a frame is determined as “Red”. When “Yellow” is determined, tokens corresponding to P bytes are removed from the EB.

FIG. 2 illustrates an outline of RFC 2698. In the RFC 2698, CB and Peak Buckets (hereafter, referred to as PB) are used. Peak information rate (PIR) is an amount of tokens per unit time that are replenished to a PB and represents the maximum band that can be used in traffic. Peak burst size (PBS) is the maximum amount of tokens that can be stored in a PB, and tokens exceeding PB are discarded. Peak bucket level at the given time t (PBL(t)) is an amount of tokens at the time (t) when a meter operation is performed. When a packet whose packet length is P bytes is received, tokens corresponding to P bytes are removed from the PB by a meter operation. When the packet length P is less than or equal to PBL(t), a frame is determined as “Green or Yellow”, and when P is greater than PBL(t), a frame is determined as “Red”. When “Green or Yellow” is determined, tokens corresponding to P bytes are removed from the PB.

Typically, a meter operation is performed when a network device receives a user packet, and tokens are replenished to token buckets as described above. The amount of tokens is calculated based on information saved in a table stored in memory (hereafter, referred to as meter table). In the case of RFC 2698, tokens of an amount corresponding to CIR* (the current access time minus a timestamp time) are replenished to the CBL, and tokens of an amount corresponding to PIR* (the current access time minus a timestamp time) are replenished to the PBL. The timestamp indicates the previous access time (that is, a time point when a meter operation was previously performed) and is saved in the meter table. Techniques relating to the above are disclosed in Japanese Laid-open Patent Publication No. 2008-28888 and Japanese Laid-open Patent Publication No. 2005-269000.

### SUMMARY

According to an aspect of the invention, a control method performed by a network device includes replenishing a token to a token bucket and updating a timestamp indicating an execution time point of a meter operation when a user packet is received from another device, generating a dummy packet different from the user packet for every certain time period, in response to the dummy packet, replenishing the token to the token bucket, updating the timestamp, and discarding the dummy packet, controlling traffic in accordance with the token within the token bucket.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an outline of MEF 10;

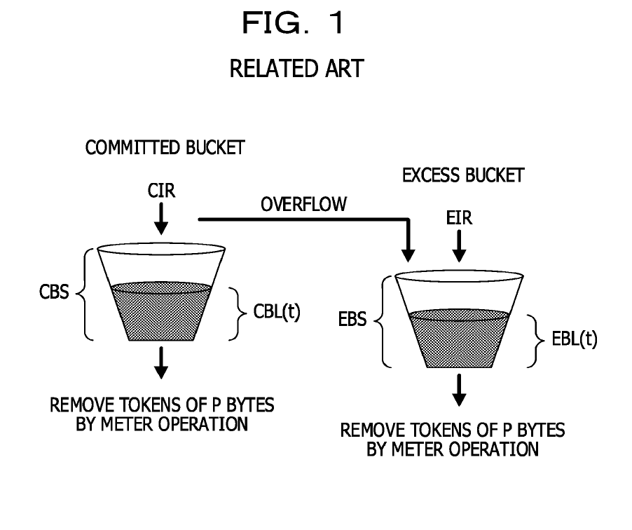

FIG. 2 is a diagram illustrating an outline of RFC 2698;

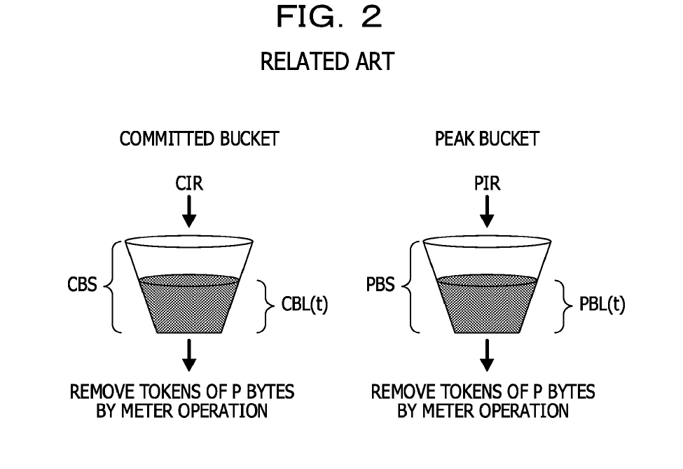

FIG. 3 is a diagram for describing token replenishment when timestamps wrap around;

FIG. 4 is a diagram illustrating an example an output rate;

FIG. 5A is a diagram illustrating a configuration of a network device;

FIG. 5B is a functional block diagram illustrating a first protocol processing unit;

FIG. 6 is a diagram illustrating an example of data stored in a meter table;

FIG. 7 is a diagram illustrating an outline of a first embodiment;

FIG. 8 is a diagram illustrating a process flow of operations performed by a first protocol processing unit in the first embodiment;

FIG. 9 is a diagram illustrating a process flow of operations performed by a second protocol processing unit in the first embodiment;

FIG. 10 is a diagram illustrating an outline of a second embodiment;

FIG. 11 is a diagram illustrating a process flow of operations performed by a first protocol processing unit in the second embodiment;

FIG. 12 is a diagram illustrating a process flow of operations performed by a second protocol processing unit in the second embodiment;

FIG. 13 is a diagram illustrating an example of a hardware configuration of a network device provided with an NPU; and

FIG. 14 is a functional block diagram of a common NPU.

### DESCRIPTION OF EMBODIMENTS

Since the bit width of a field for saving timestamps is limited, timestamps wrap around within a predetermined time period. Therefore, tokens of an appropriate amount are not replenished to token buckets when no user packet has been received for a while and when timestamps wrap around from the time of a previous access to the meter table to the time of the current access to the meter table.

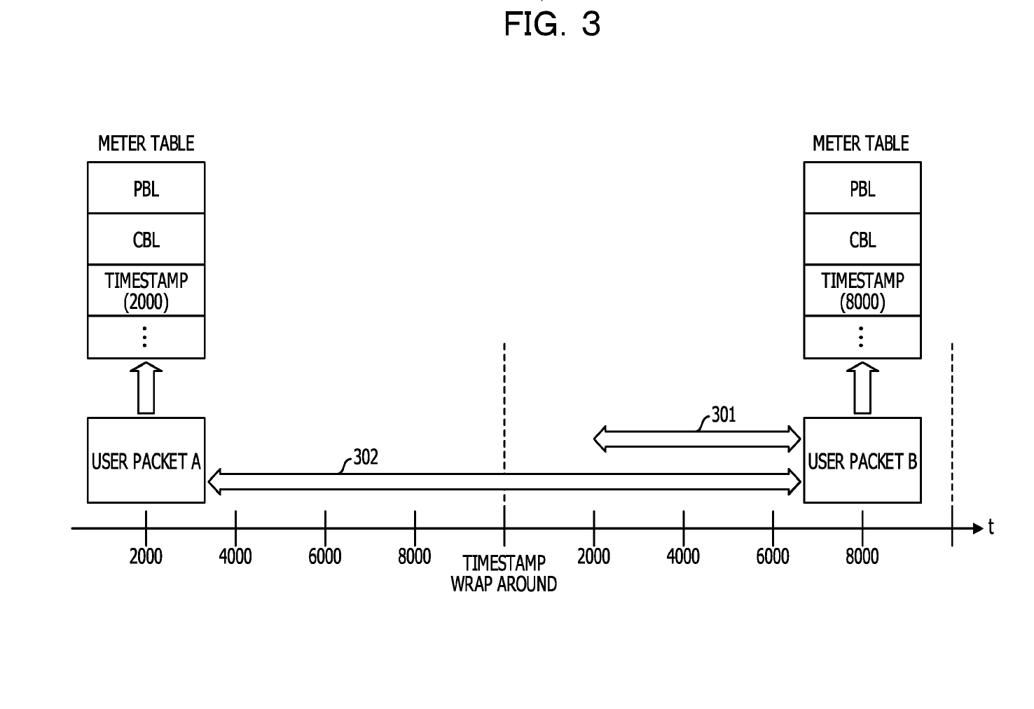

This development can be described by using FIG. 3. In FIG. 3, while a user packet A is received at the time of a timestamp “2000” and a user packet B is received at the time of a timestamp “8000”, a wrapping around of timestamps occurs between these two time points. In the case of RFC 2698, although the amount of tokens has to be calculated by CIR* (period 302) and PIR* (period 302), the amount of tokens is calculated by CIR* (period 301) and PIR* (period 301) because the timestamp at the reception time of the user packet B is “8000”. Thus, tokens of an appropriate amount are not replenished by token buckets and therefore the accuracy of meter operation decreases.

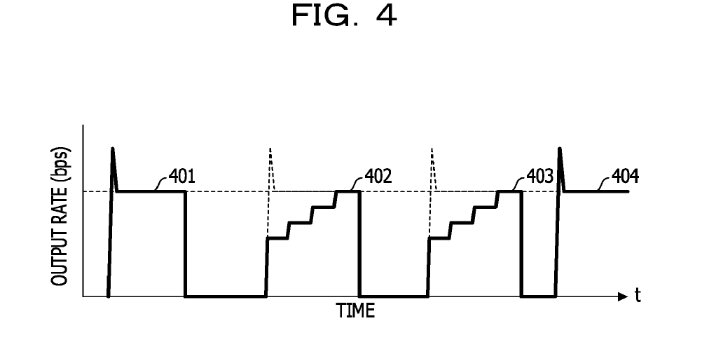

FIG. 4 illustrates an example of an output rate when a wrapping around of timestamps occurs. Typically, as seen in outputs 401 and 404, a burst output occurs such that an output rate surges at the time when packets start flowing, and an output is then obtained in accordance with a set rate. When timestamps wrap around, however, no burst output occurs and an output as seen in outputs 402 and 403 in FIG. 4 is obtained. Note that, although the increased bit width of a field for saving timestamps allows for a reduced frequency of wrapping around, this involves an increase in memory resources and thus results in an increase in cost.

Therefore, in one aspect, the present disclosure is intended to provide a technique for increasing the accuracy of meter operation.

### First Embodiment

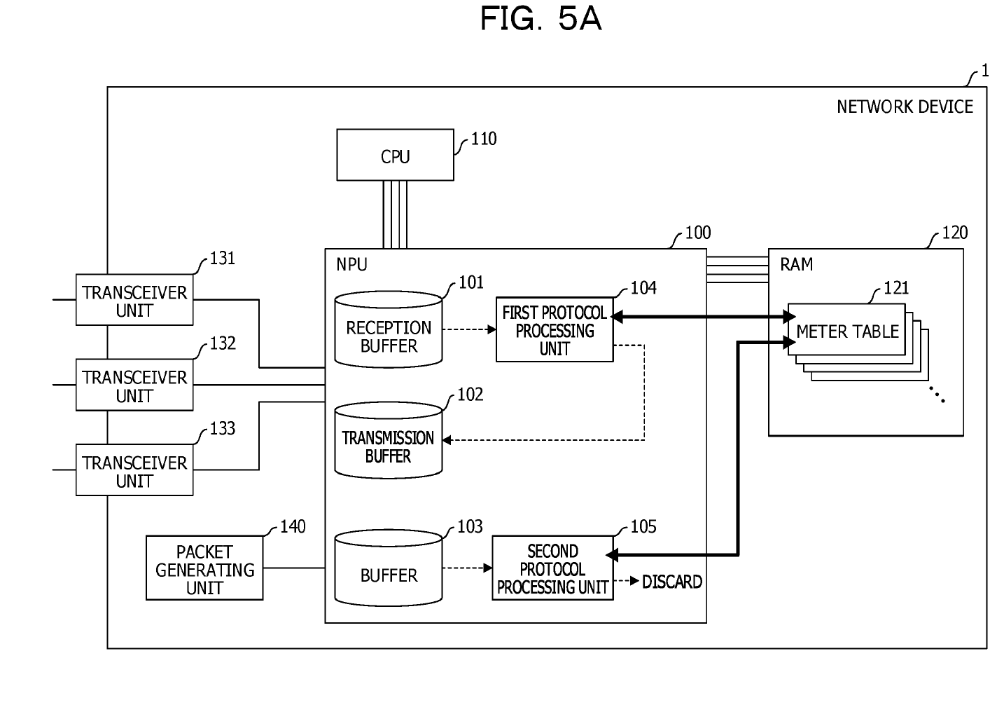

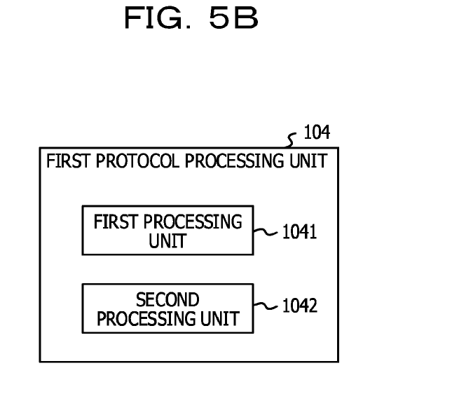

FIG. 5A illustrates a network device 1 of the present embodiment. The network device 1 has an NPU 100, a central processing unit (CPU) 110, a RAM 120 such as a static random access memory (SRAM), transceiver units 131 to 133, and a packet generating unit 140. The NPU 100 is a processor provided on the network device 1 and is a chip that is programmable for each layer of a protocol stack (for example, layer L1, layer L2, and the like). The NPU 100 is connected to the CPU 110, the RAM 120, the transceiver units 131 to 133, and the packet generating unit 140 via busses. In FIG. 5A, broken lines represent packet flow, and bold lines represent access of a meter table 121 by a first protocol processing unit 104 and access of the meter table 121 by a second protocol processing unit 105.

Firmware for performing operations of the present embodiment is executed by a processor of the NPU 100 to implement the first protocol processing unit 104 and the second protocol processing unit 105. The protocol processing unit 104 extracts a user packet received from the transceiver units 131, 132, or 133 from a receiving buffer 101 and performs a protocol process on the extracted user packet. In a meter operation (that is a meter operation of RFC 2698 in the present embodiment) of a protocol process, the meter table 121 stored in the RAM 120 is accessed. Transmittable packets are stored in a transmission buffer 102 and transmitted to their destinations via any one of the transceiver units 131 to 133. Note that details of the network device provided with the NPU 100 and the protocol process will be described later.

The second protocol processing unit 105 extracts from a buffer 103 packets that are periodically generated by the packet generating unit 140 and periodically performs a meter operation assuming that the packet length P is zero. The second protocol processing unit 105 discards packets remaining after a meter operation.

The packet generating unit 140 generates a dummy packet for every predetermined time period to output the dummy packet to a buffer 103 of the NPU 100. The packet generating unit 140 is implemented by using a Field Programmable Gate Array (FPGA), for example.

The transceiver units 131 to 133 transmit and receive packets.

FIG. 5B illustrates a functional block diagram of the first protocol processing unit 104. The first protocol processing unit 104 includes a first processing unit 1041 and a second processing unit 1042. The first processing unit 1041 performs a primary portion of a meter operation and notifies the second processing unit 1042 of a determination result regarding packet color. The second processing unit 1042 processes a packet according to a determination result. Note that, although the first protocol processing unit 104 includes other processing units for performing other operations, description thereof will be omitted here because such processing units do not directly relate to the present embodiment.

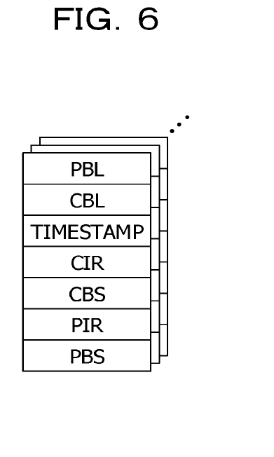

FIG. 6 illustrates an example of the meter table 121 stored in the RAM 120. The meter table 121 is prepared on an input port number basis or on a virtual local area network (VLAN) basis and is identified by using a meter identifier (ID). In the case of RFC 2698, each meter table 121 stores therein a PBL value, a CBL value, timestamp times, a CIR value, a CBS value, a PIR value, and a PBS value.

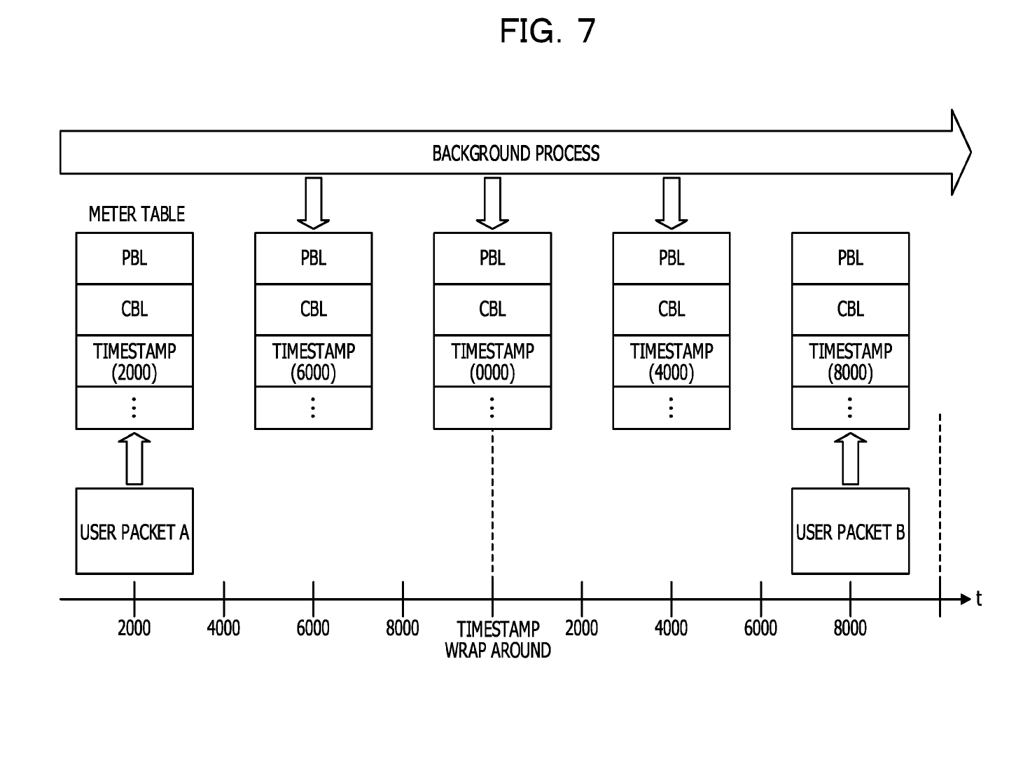

A summary of the first embodiment will be described by using FIG. 7. In the first embodiment, separately from the first protocol processing unit 104 accessing the meter table 121 in the foreground, the second protocol processing unit 105 periodically accesses the meter table 121 in the background. In the example of FIG. 7, the second protocol processing unit 105 accesses the meter table 121 every 4000 milliseconds to replenish tokens and update the timestamp. This enables a token bucket to be replenished with tokens corresponding to a time period from the reception of the packet A to the reception of the packet B (16000 milliseconds), which can suppress a reduction in the output rate.

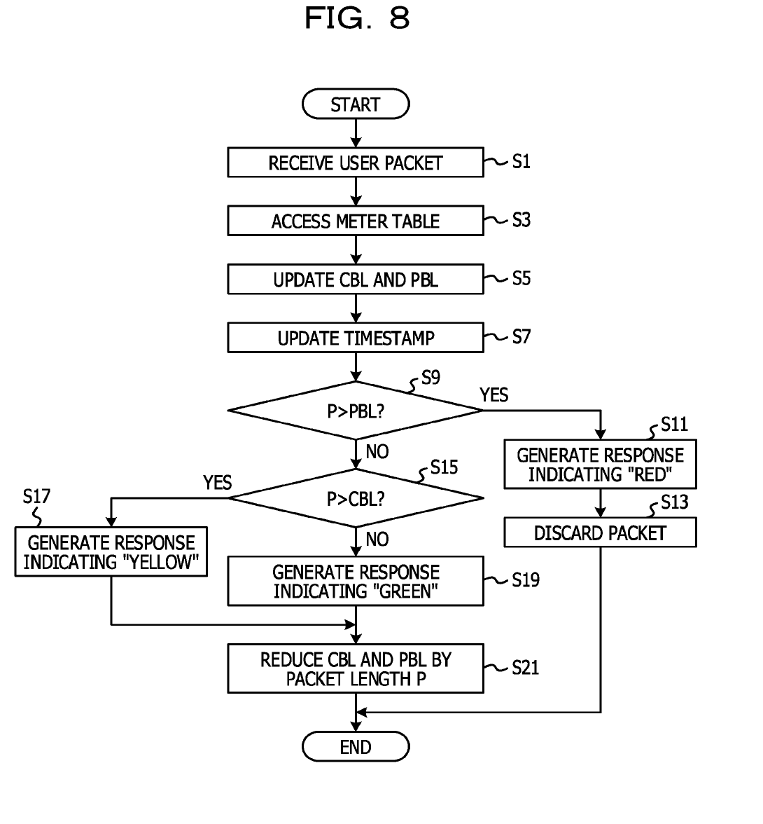

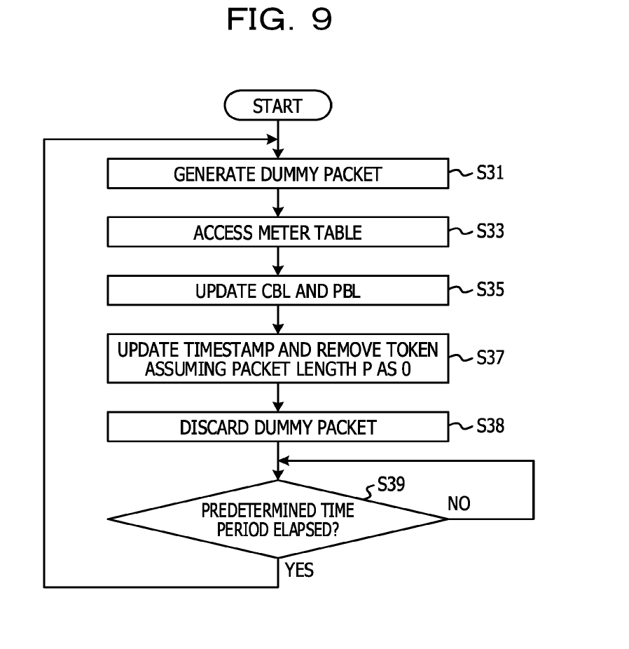

Next, a process performed in the first embodiment will be described in detail by using FIG. 8 and FIG. 9. First, a process performed by the first protocol processing unit 104 will be described by using FIG. 8.

Any one of the transceiver units 131 to 133 may receive a user packet from a network (FIG. 8: step 51). The received user packet is output to a reception buffer 101 and extracted by the first protocol processing unit 104. A user packet contains a meter ID.

The first processing unit 1041 of the first protocol processing unit 104 performs on a received user packet (hereafter, referred to as a received packet) a protocol process to be performed before a meter operation. The first processing unit 1041 then accesses the meter table 121 associated with a meter ID contained in a received packet in the RAM 120 (step S3). Specifically, the first processing unit 1041 updates the CBL and PBL stored in the meter table 121 (step S5). At step S5, CIR* (the current access time minus a timestamp time stored in the meter table 121) is added to the CBL, and PIR* (the current access time minus a timestamp time stored in the meter table 121) is added to the PBL. The current access time may be the time of performing step S3, for example.

The first processing unit 1041 updates a timestamp stored in the meter table 121 with the current access time (step S7).

The first processing unit 1041 determines whether P is greater than PBL (step S9). If P is greater than PBL (step S9: Yes), the first processing unit 1041 generates a response indicating that the color of the received packet is “Red” (step S11) and outputs the response and the received packet to the second processing unit 1042. In response, the second processing unit 1042 discards the received packet (step S13). The process then ends.

On the other hand, if P is not greater than PBL (step S9: No), the first processing unit 1041 determines whether P is greater than CBL (step S15). If P is greater than CBL (step S15: Yes), the first processing unit 1041 generates a response indicating that the color of the received packet is “Yellow” (step S17) and outputs the response and the received packet to the second processing unit 1042. Since the color of the received packet is “Yellow”, the second processing unit 1042 does not discard the received packet and outputs the received packet to a processing unit that performs a subsequent protocol process. Operation of step S21 is then started.

On the other hand, If P is not greater than CBL (step S15: No), the first processing unit 1041 generates a response indicating that the color of the received packet is “Green” (step S19) and outputs the response and the received packet to the second processing unit 1042. Since the color of the received packet is “Green”, the second processing unit 1042 does not discard the received packet and outputs the received packet to a processing unit that performs a subsequent protocol process.

The first processing unit 1041 decrements CBL and PBL stored in the meter table 121 by an amount corresponding to the packet length P (step S21). The process then ends.

Performing the process described above allows the meter table 121 to be updated in response to receiving a user packet.

Next, a process performed by the second protocol processing unit 105 will be described by using FIG. 9.

First, the packet generating unit 140 generates a dummy packet for each meter ID (FIG. 9: step S31) and outputs the dummy packet to the buffer 103. The time to be taken is shorter than the time to be taken for timestamps to wrap around. Each dummy packet contains a meter ID and, at step S31, dummy packets corresponding to the number of meter IDs are generated. To simplify the description, however, operations performed on a single dummy packet will be focused on and described below.

The second protocol processing unit 105 acquires a dummy packet from the buffer 103 and accesses the meter table 121 (in this illustration, a meter table corresponding to a meter ID contained in the dummy packet) (step S33). Specifically, the second protocol processing unit 105 updates CBL and PBL stored in the meter table 121 (step S35). At step S35, CIR* (the current access time minus a timestamp stored in the meter table 121) is added to CBL, and PIR* (the current access time minus a timestamp stored in the meter table 121) is added to PBL. The current access time may be the time of performing step S33, for example.

The second protocol processing unit 105 updates a timestamp stored in the meter table 121 with the current access time and removes tokens from CBL and PBL assuming that the packet length P is zero (step S37). Since P is equal to zero, however, PBL and CBL do not change. With such a process, the situation whereby tokens are consumed by a dummy packet can be avoided.

The second protocol processing unit 105 discards the dummy packet (step S38) and determines whether a predetermined time period has elapsed since the previous meter operation being performed (step S39). If a predetermined time period has not elapsed since execution of the previous meter operation (step S39: No), the process returns to step S39. On the other hand, if a predetermined time period has elapsed since execution of the previous meter operation (step S39: Yes), the process returns to step S31.

As discussed above, since tokens are replenished to token buckets in every predetermined time period, the situation where tokens of an amount that is considerably different from the amount to be actually replenished are replenished is avoided, even when there is a long period of no user packet being received. This can suppress a reduction in the accuracy of meter operation.

Note that, while it appears to be possible to increase the time period in which wrapping around occurs by reducing the accuracy of a timer utilized in updating a timestamp, this can cause a problem of the replenishing amount of tokens being not appropriately calculated. Further, while it appears to be possible to periodically replenish a fixed amount of tokens as a method for not using a timestamp, the increased number of meter tables to be updated causes a process to be delayed and an update time point to be shifted, and thus no burst output is obtained. Therefore, the method of the present embodiment is superior to the above methods.

### Second Embodiment

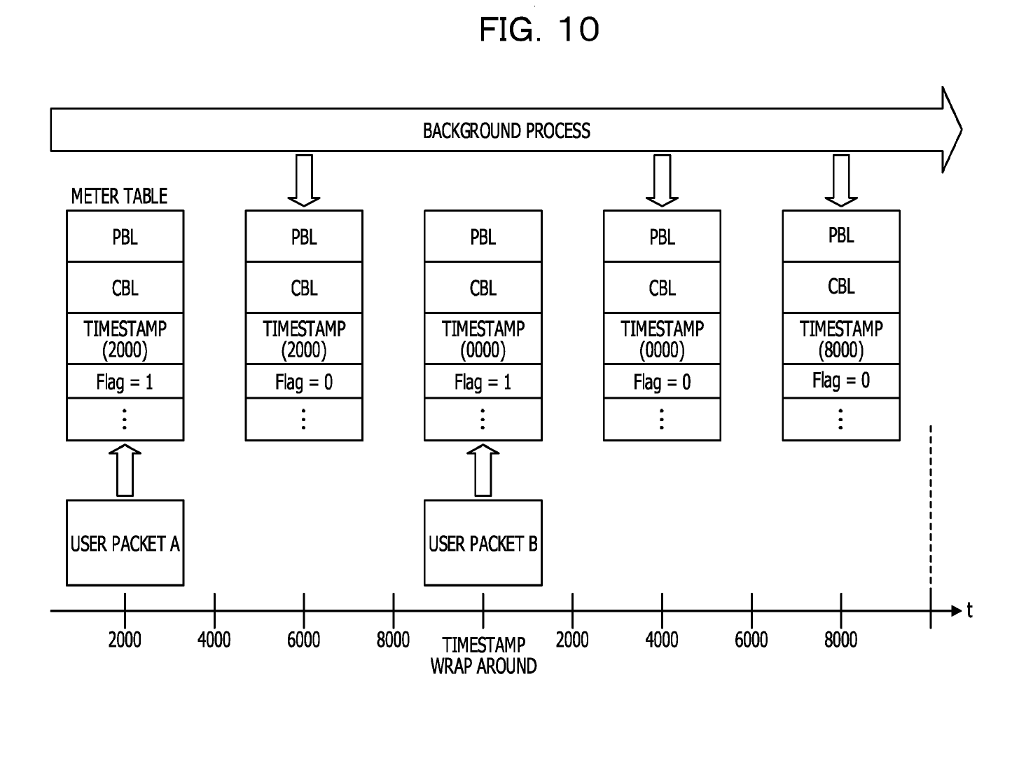

Summary of the second embodiment will be described by using FIG. 10. In the second embodiment, in a similar manner to the first embodiment, separately from the first protocol processing unit 104 accessing the meter table 121 in the foreground, the second protocol processing unit 105 periodically accesses the meter table 121 in the background. However, replenishment of tokens and updating of a timestamp are not necessarily performed, but replenishment of tokens and updating of a timestamp are performed only when the previous access is not caused by a user packet (that is, the flag in the meter table 121 is 0). In the example of FIG. 10, while access to the meter table 121 is performed three times by a background process, replenishment of tokens and updating of a timestamp are actually performed only once. In this way, replenishment of tokens and updating of a timestamp are performed only when a predetermined condition is met, which can suppress an increase in the processing load of the NPU 100.

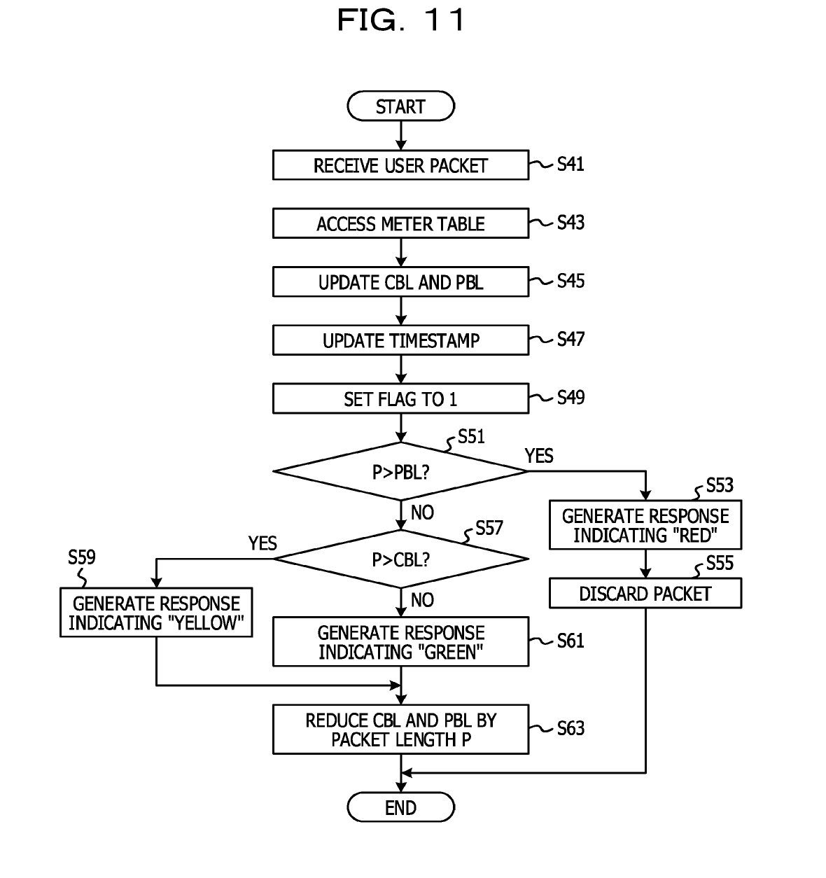

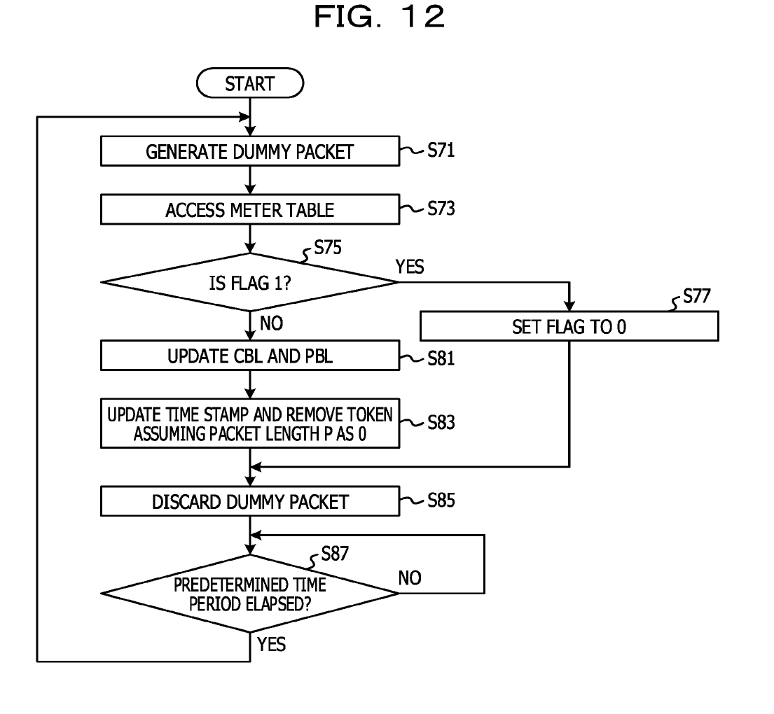

Next, a process performed in the second embodiment will be described in detail by using FIG. 11 and FIG. 12. First, a process performed by the first protocol processing unit 104 will be described by using FIG. 11.

Any one of the transceiver units 131 to 133 receives a user packet from a network (FIG. 11: step S41). The received user packet is output to the reception buffer 101 and extracted by the first protocol processing unit 104. A user packet contains a meter ID.

The first processing unit 1041 of the first protocol processing unit 104 performs on a received user packet (hereafter, referred to as received packet) a protocol process to be performed before a meter operation. The first processing unit 1041 then accesses the meter table 121 associated with a meter ID included in a received packet in the RAM 120 (step S43). Specifically, the first processing unit 1041 updates CBL and PBL stored in the meter table 121 (step S45). At step S45, CIR* (the current access time minus a timestamp stored in the meter table 121) is added to CBL, and PIR* (the current access time minus a timestamp stored in the meter table 121) is added to PBL. The current access time may be the time of performing step S43, for example.

The first processing unit 1041 updates a timestamp stored in the meter table 121 with the current access time (step S47) and sets a flag stored in the meter table 121 to 1 (step S49).

The first processing unit 1041 determines whether P is greater than PBL (step S51). If P is greater than PBL (step S51: Yes), the first processing unit 1041 generates a response indicating that the color of the received packet is “Red” (step S53) and outputs the response and the received packet to the second processing unit 1042. In response, the second processing unit 1042 discards the received packet (step S55). The process then ends.

On the other hand, if P is not greater than PBL (step S51: No), the first processing unit 1041 determines whether P is greater than CBL (step S57). If P is greater than CBL (step S57: Yes), the first processing unit 1041 generates a response indicating that the color of the received packet is “Yellow” (step S59) and outputs the response and the received packet to the second processing unit 1042. Since the color of the received packet is “Yellow”, the second processing unit 1042 does not discard the received packet and outputs the received packet to a processing unit that performs a subsequent protocol process. Operation of step S63 is then started.

On the other hand, If P is not greater than CBL (step S57: No), the first processing unit 1041 generates a response indicating that the color of the received packet is “Green” (step S61) and outputs the response and the received packet to the second processing unit 1042. Since the color of the received packet is “Green”, the second processing unit 1042 does not discard the received packet and outputs the received packet to a processing unit that performs a subsequent protocol process.

The first processing unit 1041 decrements CBL and PBL stored in the meter table 121 by an amount for the packet length P (step S63). The process then ends.

Performing the process described above allows the meter table 121 to be updated in response to receiving a user packet and, further, the second protocol processing unit 105 to confirm that an access has been based on a user packet.

Next, a process performed by the second protocol processing unit 105 will be described by using FIG. 12.

First, the packet generating unit 140 generates a dummy packet for each meter ID (FIG. 12: step S71) and outputs the dummy packet to the buffer 103. The time to be taken is shorter than the time to be taken for timestamps to wrap around. Each dummy packet contains a meter ID and, at step S71, dummy packets for the number of meter IDs are generated. To simplify the description, however, a process performed on a single dummy packet will be focused on and described below.

The second protocol processing unit 105 acquires a dummy packet from the buffer 103 and accesses the meter table 121 (in this illustration, a meter table corresponding to a meter ID contained in the dummy packet) (step S73), and determines whether the flag stored in the meter table 121 is set to 1 (step S75).

If the flag has been set to 1 (step S75: Yes), the second protocol processing unit 105 sets the flag stored in the meter table 121 to 0 (step S77). Operation of step S85 is then entered.

On the other hand, if the flag has not been set to 1 (step S75: No), the second protocol processing unit 105 updates CBL and PBL stored in the meter table 121 (step S81). At step S81, CIR* (the current access time minus a timestamp stored in the meter table 121) is added to CBL, and PIR* (the current access time minus a timestamp stored in the meter table 121) is added to PBL. The current access time may be the time of performing step S73, for example.

The second protocol processing unit 105 updates a timestamp stored in the meter table 121 with the current access time and removes tokens from CBL and PBL assuming that the packet length P is zero (step S83). Since P is equal to zero, however, PBL and CBL do not change. With such a process, the situation whereby tokens are consumed by a dummy packet can be avoided.

The second protocol processing unit 105 discards the dummy packet (step S85) and determines whether a predetermined time period has elapsed since execution of the previous meter operation (step S87). If a predetermined time period has not elapsed since execution of the previous meter operation (step S87: No), the process returns to step S87. On the other hand, if a predetermined time period has elapsed since execution of the previous meter operation (step S87: Yes), the process returns to step S71.

The process as described above can suppress a reduction in the accuracy of meter operation while maintaining a lower processing load of the NPU 100.

Although embodiments of the present disclosure have been described above, the present disclosure is not limited thereto. For example, the configuration of the network device 1 described above may not correspond to a configuration of an actual program module.

Further, the table configuration described above is an example and does not have to be consistent with the configuration described above. Furthermore, the order of operations can be exchanged as long as the process result does not change. Moreover, some operations may be performed in parallel.

Further, the CPU 110 may periodically generate dummy packets without the packet generating unit 140 being provided. Further, dummy packets may be periodically acquired from an external device of the network device 1.

Techniques related to the present embodiments will be described below.

1. Network Configuration Provided with NPU

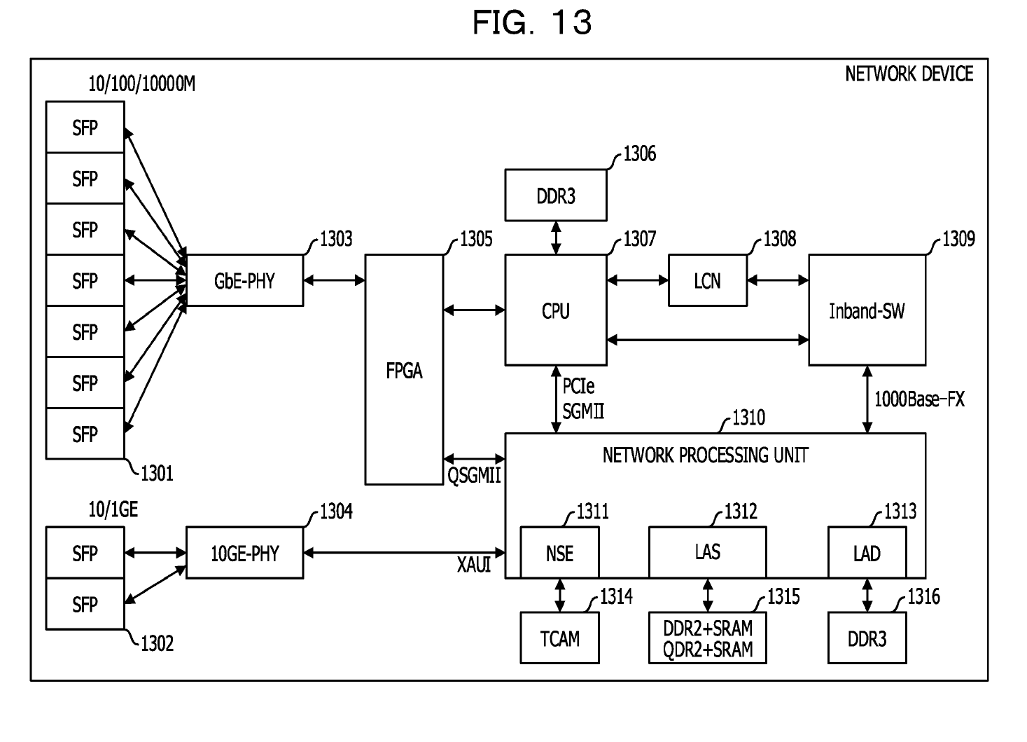

FIG. 13 is a diagram illustrating an example of a configuration of a network device provided with the NPU. The network device has a plurality of small form-factor pluggable (SFP) modules 1301 connected to a gigabit Ethernet (“Ethernet” is a registered trademark) physical circuit (represented as “GbE-PHY”) 1303, a plurality of SFP modules 1302 connected to a 10-gigabit Ethernet physical circuit (represented as “10GE-PHY”) 1304, an FPGA 1305, a double data rate 3 (DDR3) synchronous dynamic random access memory (SDRAM) 1306, a CPU 1307, a LAN control network (LCN) 1308 for out-band accessing (for example, controlling and monitoring) the CPU 1307, an in-band switch (represented as “Inband-SW”) 1309 for in-band accessing the CPU 1307, an NPU 1310, a ternary content addressable memory (TCAM) 1314, a memory 1315 including a double data rate 2 (DDR2) SDRAM and SRAM or a quad data rate 2(QDR2) SRAM, and a DDR3 SDRAM 1316. The NPU 1310 has a network search engine (NSE) 1311, a look-aside SRAM (LAS) 1312 that increases the speed of a conversion from the virtual address into the physical address, and a look-aside DRAM (LAD) 1313. In FIG. 13, QSGMII stands for Quad Serial Gigabit Media Independent Interface, XAUI stands for 10 Gigabit Attachment Unit Interface, PCIe stands for Peripheral Component Interconnect, and SGMII stands for Serial Gigabit Media Independent Interface.

2. Protocol Process

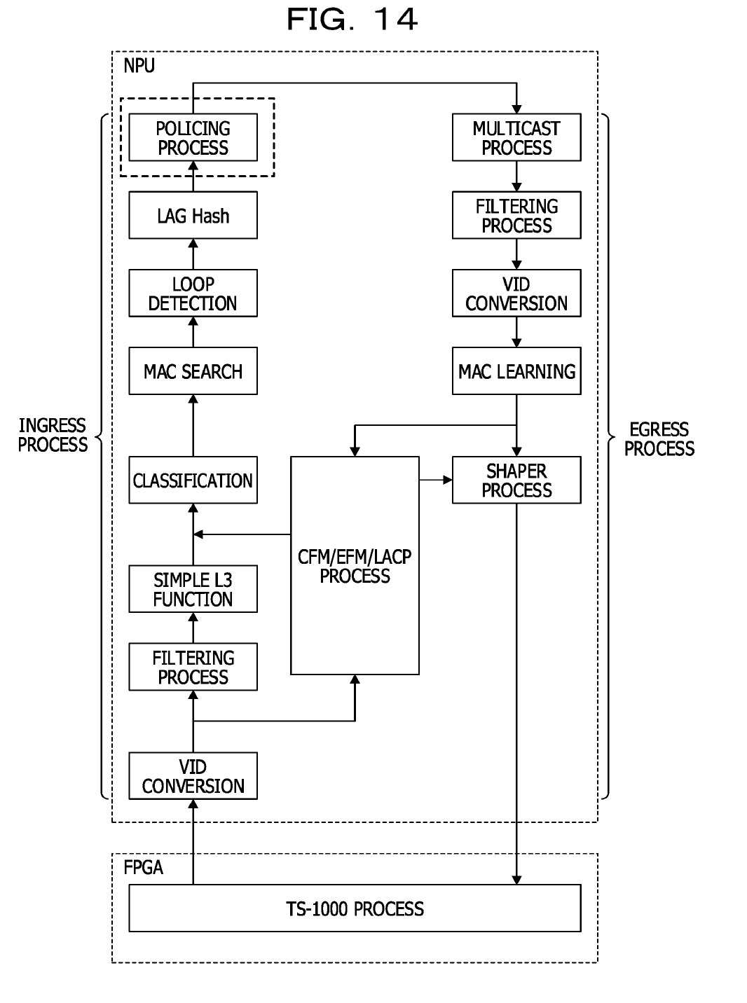

FIG. 14 illustrates an example of a functional block diagram of a common NPU. In the NPU, a VLAN identifier (VID) conversion is performed based on a result of TS-1000 operation by an FPGA. Operations from a VID conversion to a policing operation (this operation corresponds to a meter operation) are referred to as Ingress process. Operations from a multicast operation to a shaper operation that are performed after an Ingress process are referred to as Egress process.

The embodiments of the present disclosure described above can be summarized as follows.

The meter processing method according to the present embodiments includes operations of (A) acquiring a dummy packet for every predetermined time period and (B) replenishing tokens to a token bucket based on the acquired dummy packet and updating a timestamp indicating an execution time point of a meter operation.

With this method, an amount of tokens in a token bucket can be set to an appropriate value even when a timer wraps around, and therefore the accuracy of a meter operation can be increased.

The present meter processing method may further include an operation of (C) determining whether the previous update of the timestamp is based on a packet received from an external device. Then, an operation of (b1) replenishing a token to a token bucket and updating the timestamp may be performed when the previous updating of the timestamp is based on the packet received from the external device. This can suppress execution of excessive operations and thus the processing load of a processor can be reduced.

Further, in the operation of updating a timestamp, the method may (b2) calculate the number of tokens to be replenished to a token bucket based on a timestamp before the updating and current execution time point, (b3) replenish the calculated number of tokens to the token bucket, and (b4) update the timestamp before the updating with the current execution time point. This allows for appropriately controlling the transferring amount of packets.

Further, the present meter processing method may include an operation of (D) updating an amount of tokens within a token bucket assuming that a packet length of the dummy packet is zero. Thereby, the situation whereby tokens are consumed by a dummy packet can be avoided.

Further, the time to be taken described above may be shorter than the time before a timestamp wraps around.

In addition, a program that causes a processor to execute operations of the method described above, and such a program may be stored in a computer readable storage medium or storage device such as a flexible disk, a CD-ROM, an optical magnetic disk, a semiconductor memory, a hard disk, and the like, for example. Note that an intermediate processing result is temporarily saved in a storage device such as a main memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A control method performed by a network device, the control method comprising:
replenishing a token to a token bucket and updating a timestamp indicating an execution time point of a meter operation when a user packet is received from another device;
generating a dummy packet different from the user packet for every certain time period;
in response to the dummy packet, replenishing the token to the token bucket, updating the timestamp, and discarding the dummy packet; and
controlling traffic in accordance with the token within the token bucket.

2. The control method according to claim 1, further comprising:
determining whether a previous updating of the timestamp is based on the user packet.

3. The control method according to claim 2, further comprising:
when a previous updating of the timestamp is based on the user packet, performing an operation of replenishing the token to the token bucket and another operation of updating the timestamp in response to the dummy packet.

4. The control method according to claim 1, further comprising:
calculating an amount of the token to be replenished to the token bucket based on another timestamp before updating and on a time point of replenishing the token by the dummy packet; and
replenishing the token corresponding to the amount to the token bucket.

5. The control method according to claim 1, further comprising:
updating an amount of the token within the token bucket assuming that a packet length of the dummy packet is zero.

6. The control method according to claim 1, wherein the certain time period is shorter than a time period in which the timestamp wraps around.

7. A meter processing method comprising:
acquiring a dummy packet for every certain time period;
replenishing a token to a token bucket based on the acquired dummy packet; and
updating a timestamp indicating an execution time point of a meter operation.

8. A network device comprising:
a memory; and
a processor coupled to the memory and configured to:
replenish a token to a token bucket and update a timestamp indicating an execution time point of a meter operation when a user packet is received from another device,
generate a dummy packet different from the user packet for every certain time period,
in response to the dummy packet, replenish the token to the token bucket, update the timestamp, and discard the dummy packet, and
control traffic in accordance with the token within the token bucket.

9. The network device according to claim 8, wherein the processor is configured to:
determine whether a previous updating of the timestamp is based on the user packet.

10. The network device according to claim 9, wherein the processor is configured to:
when a previous updating of the timestamp is based on the user packet, perform an operation of replenishing the token to the token bucket and another operation of updating the timestamp in response to the dummy packet.

11. The network device according to claim 8, wherein the processor is configured to:
calculate an amount of the token to be replenished to the token bucket based on another timestamp before updating and on a time point of replenishing the token by the dummy packet, and
replenish the token corresponding to the amount to the token bucket.

12. The network device according to claim 8, wherein the processor is configured to:
update an amount of the token within the token bucket assuming that a packet length of the dummy packet is zero.

13. The network device according to claim 8, wherein the certain time period is shorter than a time period in which the timestamp wraps around.
